(19) United States
(12) Patent Application Publication
(10) Pub. No.: US 2012/0144671 A1
(43) Pub. Date: Jun. 14, 2012

(54) GAS COMPRESSOR WITH PULSATION ABSORBER FOR REDUCING CYLINDER NOZZLE RESONANT PULSATION

(75) Inventors: Ralph E. Harris, San Antonio, TX (US); Eugene L. Broerman, III, San Antonio, TX (US); Mitchell A. Smolik, San Antonio, TX (US)

(73) Assignee: Southern Gas Association Gas Machinery Research Council, Dallas, TX (US)

(21) Appl. No.: 13/400,849

(22) Filed: Feb. 21, 2012

Related U.S. Application Data
(62) Division of application No. 11/734,116, filed on Apr. 11, 2007.

(51) Int. Cl. B23P 6/00

(52) U.S. Cl. 29/888.021

(57) ABSTRACT

A method for reducing pulsation effects associated with the compressor nozzle of a positive displacement compressor system. A pulsation absorber, having a design like that of a side branch absorber, is installed on the cylinder valve cap or on the cylinder nozzle. The acoustic dimensions and placement of the pulsation absorber are designed to reduce the amplitude of the pulsations associated with the peak resonant frequency of the compressor nozzle response.

### TECHNICAL FIELD OF THE INVENTION

This invention relates to large positive displacement compressors for transporting fluids, and more particularly to an improved method for reducing cylinder nozzle pulsations in large positive displacement compressors.

### BACKGROUND OF THE INVENTION

Most natural gas consumed in the United States is not produced close to where it is used. To transport gas from increasingly remote production sites to consumers, pipeline companies operate and maintain hundreds of thousands of miles of natural gas transmission lines. The gas is then sold to local distribution companies, who deliver it to consumers, using a network of more than a million miles of local distribution lines. This vast underground transmission and distribution system is capable of moving billions of cubic feet of gas each day.

To provide force to move the gas, operators install large gas compressors at transport stations along the pipelines. Reciprocating compressors are a type of positive displacement compressor that compress gas by using a piston in a cylinder and a back-and-forth motion. A suction valve in the cylinder receives input gas, which is compressed, and discharged through a discharge valve. Reciprocating compressors inherently generate transient pulsating flows, and various devices and control methods have been developed to control these pulsations. A proper pulsation control design reduces system pulsations to acceptable levels without compromising compressor performance.

The state of the art in pulsation design and control technology has evolved as compressor technology has changed. Designs for low-speed compressors are more mature, with fewer critical issues. However, relatively recent high-speed, high-horsepower compressor designs are placing significant challenges on pulsation control design.

Cylinder nozzle pulsations are one challenge to high-horsepower, high-speed, variable-speed units. The cylinder nozzle is the section of pipe that connects the cylinder to the suction or discharge side of the compressor, typically to a filter bottle. This section of pipe can provide significant resonance responses.

Currently, one solution to attenuating cylinder nozzle pulsations is the installation of an orifice in the cylinder nozzle. For example, a plate with a flow restricting hole may be placed across the circumference of the nozzle. However, a downside of the orifice is that it causes a pressure drop that requires the supply of additional horsepower. This burden can be significant on large horsepower units.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an integrated (low speed) compressor system.

FIG. 2 illustrates a separable (low or high speed) compressor system.

FIGS. 3A and 3B illustrate a nozzle pulsation absorber installed at alternative locations.

FIG. 4 illustrates test data of cylinder nozzle pulsations without a nozzle pulsation absorber.

FIG. 5 illustrates test data of cylinder nozzle pulsations with a nozzle pulsation absorber installed on the valve cap.

FIG. 6 illustrates test data of cylinder nozzle pulsations with a nozzle pulsation absorber installed on the cylinder nozzle.

FIGS. 7-9 illustrate how the cylinder nozzle resonance is altered when the pulsation absorber is installed near the compressor valves.

### DETAILED DESCRIPTION OF THE INVENTION

As explained in the Background, large reciprocating compressors used in the gas and processing industries generate cylinder nozzle pulsations that can cause poor compressor performance, poor valve life, and significant vibration issues. The conventional approach to reducing nozzle pulsation is the installation of an orifice.

The following description is directed to a “nozzle pulsation absorber” which when properly designed, can significantly reduce the cylinder nozzle resonant pulsations. The nozzle pulsation absorber can absorb cylinder nozzle resonant pulsations such that the maximum pulsations are drastically reduced, eliminating the need for an orifice. Unlike a conventional orifice, the nozzle pulsation absorber does require additional horsepower.

Similar to the conventional orifice, the nozzle pulsation absorber can be easily installed on an existing system at valve up. It can also be installed in the cylinder nozzle near the cylinder flange, but for existing systems this is a more costly alternative.

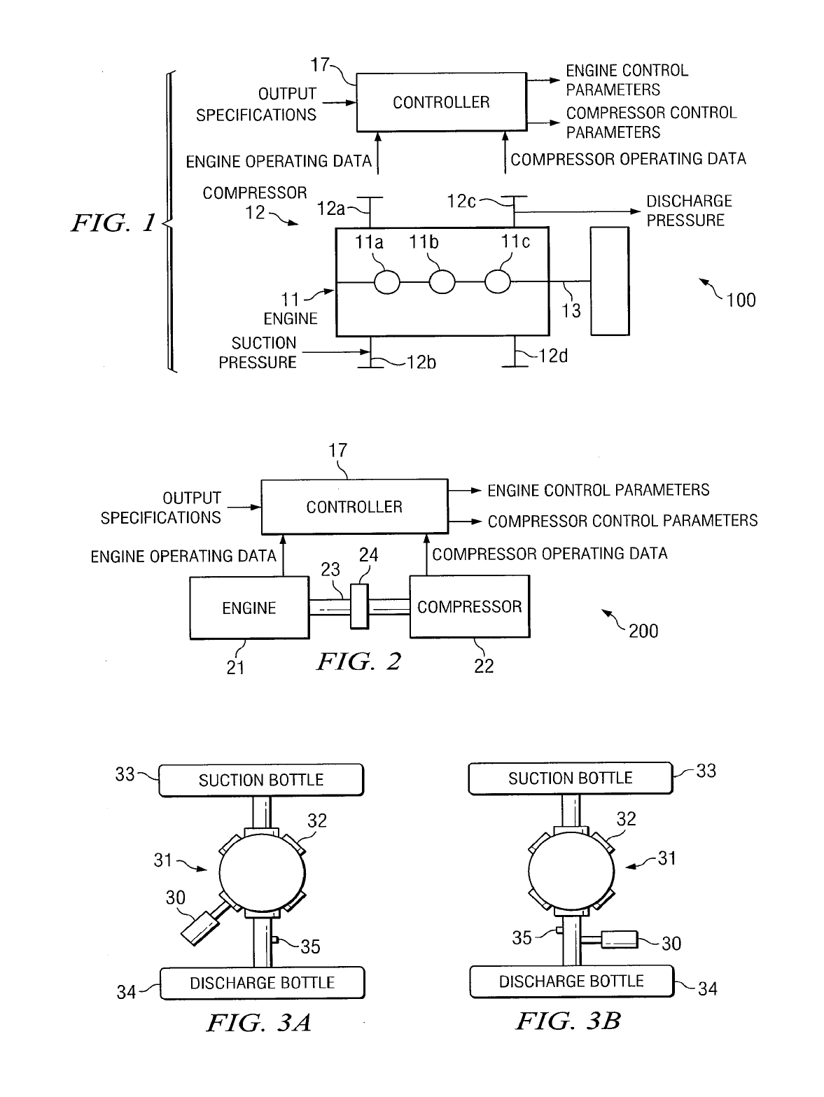

FIG. 1 illustrates a reciprocating gas compressor system 100. Compressor system 100 is an “integrated” compressor system in the sense that its engine 11 and compressor 12 share the same crankshaft 13. The engine 11 is represented by three engine cylinders 11a-11c. Typically, engine 11 is a two-stroke engine. The compressor 12 is represented by four compressor cylinders 12a-12d. In practice, engine 11 and compressor 12 may each have fewer or more cylinders.

FIG. 2 illustrates a reciprocating gas compressor system 200 in which the engine 21 and compressor 22 are separate units. This engine/compressor configuration is referred to in the natural gas industry as a “separable” compressor system. The respective crankshafts 23 of engine 21 and compressor 22 are mechanically joined at a coupling 24, which permits engine 21 to drive the compressor 22.

As indicated in the Background, a typical application of gas compressor systems 100 and 200 is in the gas transmission industry. System 100 is typically a low speed system, whereas system 200 can be a low or high speed system. The trend in the last decade is toward separable (high speed) systems, which have a smaller footprint and permit coupling to either an engine or electric motor.

Both systems 100 and 200 are characterized by having a reciprocating compressor 12 or 22, which has one or more internal combustion cylinders. Both systems have a controller 17 for control of parameters affecting compressor load and capacity. Both systems can exhibit the residual frequency problems discussed above.

As shown in FIG. 1, the compressor systems operate between two gas transmission lines. A first line, at a certain pressure, is referred to as the suction line. A second line, at a higher pressure, is referred to as the discharge line. Typically, the suction pressure and discharge pressure are measured in psi (pounds per square inch).

The following description is written in terms of the separable system 200. However, the same concepts are applicable to system 100; as indicated in FIGS. 1 and 2, the same controller 17 may be used with either type of system.

FIGS. 3A and 3B illustrate a nozzle pulsation absorber 30 installed at alternative locations, namely, the cylinder valve cap 32 (FIG. 3A) and the cylinder nozzle 35 (FIG. 3B). Only a single cylinder 31 is represented, shown as an elevation view toward its valve cap 32. Cylinder 31 could be one of the cylinders from either system shown in FIG. 1 or FIG. 2.

The cylinder nozzle 35 is the section of pipe that connects the cylinder 31 to the discharge or suction side of the compressor. In the embodiment of FIGS. 3A and 3B, the cylinder nozzle 35 is labeled on the discharge side of the compressor, and the nozzle pulsation absorber 30 is on the discharge side of cylinder 31. However, the nozzle pulsation absorber 30 may be on either the suction or discharge side of the cylinder 31.

In the embodiments of FIGS. 3A and 3B, the cylinder 31 is connected to filter bottles 33 and 34 at both the suction input and discharge outlet. These filter bottles 33 and 34 are installed as a common method for pulsation control, and are placed between the compressor and the attached piping systems. These filter bottles 33 and 34 operate with surge volumes, and are commonly implemented as volume-choke-volume devices. They function as low-pass acoustic filters, and attenuate pulsations on the basis of a predetermined Helmholtz response.

Each nozzle pulsation absorber 30 operates like a side branch absorber, and has a choke tube 30a and surge volume 30b. Choke tube 30a is a span of piping connecting the valve cap 32 or cylinder nozzle 35 to the surge volume 30b. In accordance with the invention, nozzle pulsation absorber 30 reduces pulsations by altering the frequency of the responses in the cylinder nozzle 35.

As is known in the art of side branch absorbers (also known as Helmholtz resonators) for other applications, the physical dimensions of choke tube 30a and surge volume 30b are not the same as their acoustic dimensions. The desired acoustic dimensions and the resulting physical dimensions are determined by various known calculation and acoustic modeling techniques.

The acoustic dimensions of pulsation absorber 30 vary depending on the pulsation frequency to be dampened. The resonant frequency to be damped may be determined by various measurement or predictive techniques.

The connecting piping 30a is attached to the valve cap 32 or nozzle 35, such that pulsations corresponding to the acoustic natural frequency of the pulsation absorber 30 are absorbed from the compressor system. The diameter and size of the connecting piping 30a and the size of the surge volume 30b determine the acoustic natural frequency of the pulsation absorber 30.

Advantages of the above-described nozzle pulsation absorber 30 are that it controls cylinder nozzle pulsations, with significant reduction of peak pulsation amplitudes and pulsations at resonance. Its design is simple, and it is easy to install on an existing system.

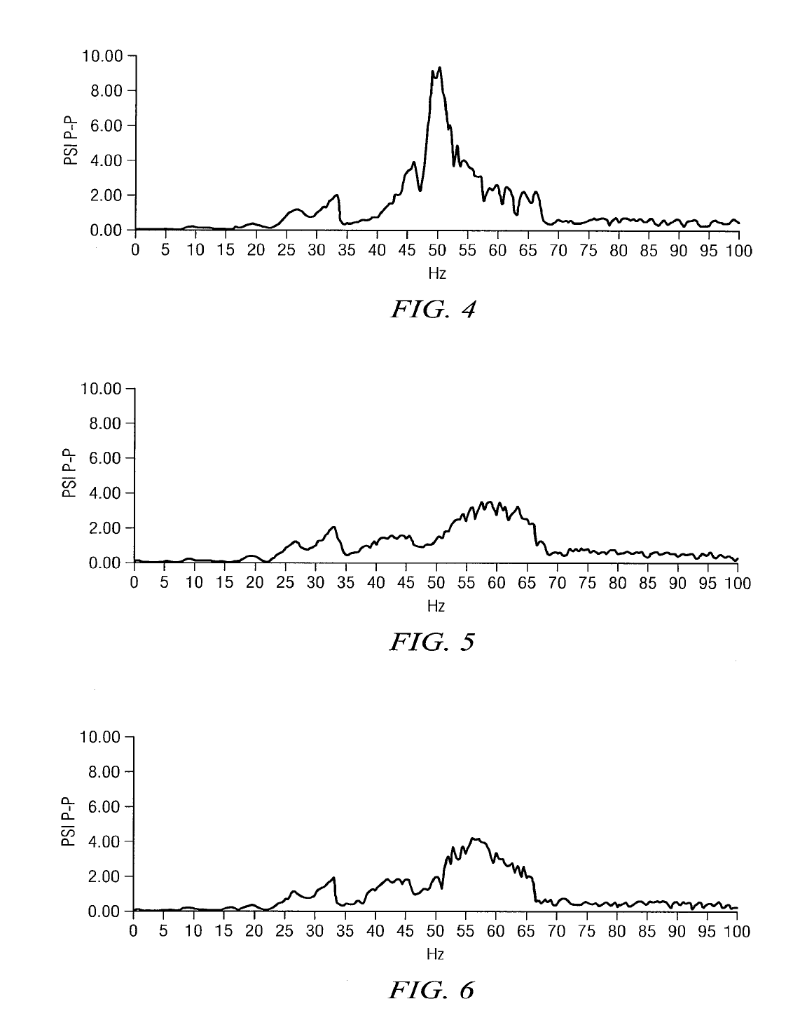

FIG. 4 illustrates test data from a compressor having a 8.5 inch bore and 3 inch stroke, running at 500 to 1000 rpm, without a nozzle pulsation absorber. As illustrated, the cylinder nozzle response has a significant peak at approximately 50 Hz.

FIG. 5 illustrates test data from the same compressor, under the same operating conditions as FIG. 4, but with a nozzle pulsation absorber 30 installed on the valve cap 32. As illustrated, the cylinder nozzle response is split, to approximately 43 and 58 Hz.

FIG. 6 illustrates test data from the same compressor, under the same operating conditions as FIG. 4, but with a nozzle pulsation absorber 30 installed on the cylinder nozzle 35. As illustrated, the cylinder nozzle response is split, to approximately 42 and 56 Hz.

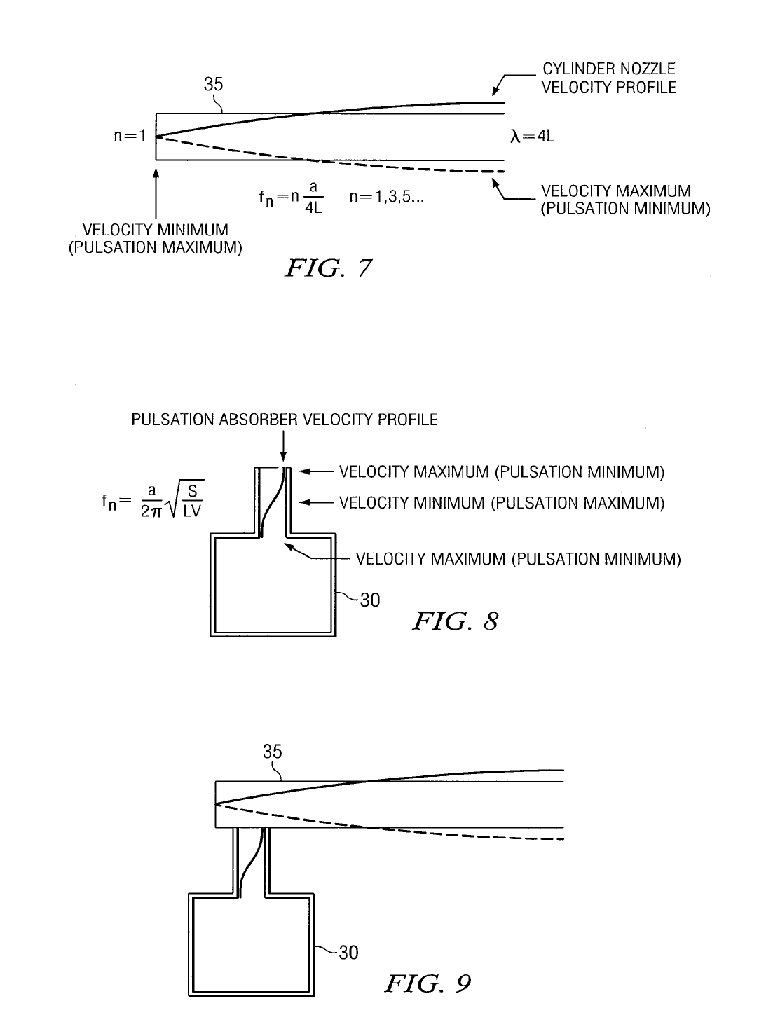

FIGS. 7-9 illustrate how the cylinder nozzle resonance is altered when the pulsation absorber is installed near the compressor valves. FIG. 7 depicts the velocity profile that is typically associated with a cylinder nozzle resonance. FIG. 8 depicts the velocity profile that is typically associated with a side branch resonator. As shown in FIG. 9, by installing the pulsation absorber near the compressor valves, a gas velocity “maximum” is generated at the location where a velocity “minimum” would typically form when the pulsation absorber is not installed.

What is claimed is:

1. A method of reducing pulsations associated with the compressor nozzle of a positive displacement compressor, comprising:
measuring the resonant frequency of the pulsations;
placing a side branch absorber on the cylinder nozzle;
wherein the side branch absorber has a surge volume and a choke tube;
wherein the side branch absorber has the following dimensions operable to reduce the peak pulsation amplitude of the resonant frequency; volume of the surge volume, length of the choke tube, and diameter of the choke tube.

2. The method of claim 4, wherein the side branch absorber has an acoustic frequency that splits the cylinder nozzle frequency response.

3. The method of claim 4, wherein the pulsation absorber is placed at a location such that a gas velocity “maximum” is generated at the location where a velocity “minimum” would typically form when the pulsation absorber is not installed.
